(19) United States
(12) Patent Application Publication
(10) Pub. No.: US 2007/0048057 A1
(43) Pub. Date: Mar. 1, 2007

(54) Head gap adjusting device and inkjet image forming apparatus including the same

(75) Inventors: Karp-sik Youn, Hwaseong-si (KR); Heon-soo Park, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/505,432

(22) Filed: Aug. 17, 2006

(30) Foreign Application Priority Data
Aug. 30, 2005 (KR) 2005-79992

(51) Int. Cl. B41J 25/308

(52) U.S. Cl. 400/58; 347/8

(57) ABSTRACT

A head gap adjusting device includes a platen including a plurality of medium supporting projections to support a printing medium, the plurality of medium supporting projections formed on a surface of the platen facing an array type printhead having a nozzle array at least equal to or longer than a width of the printing medium, a moving element to move the medium supporting projections towards or away from the printhead to adjust the head gap, and a controller to control the moving element; and an inkjet image forming apparatus including the head gap adjusting device.

### CROSS-REFERENCE TO RELATED APPLICATIONS

This application claims priority under 35 U.S.C. §119(a) from Korean Patent Application No. 10-2005-0079992, filed on Aug. 30, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a device to adjust a head gap according to a thickness of a printing medium, and an inkjet image forming apparatus including the device.

2. Description of the Related Art

Recently, a wide array type inkjet image forming apparatus, which produces an image by ejecting ink onto a printing paper using a plurality of nozzles formed on a printhead in a widthwise direction of the printing paper, has been actively studied. Such a wide array inkjet image forming apparatus performs printing faster than a shuttle type inkjet image forming apparatus, which forms an image using an ink cartridge that moves forward and backward in a widthwise direction of a printing paper.

FIG. 1 is a cross-sectional view illustrating a printhead and a platen of a conventional inkjet image forming apparatus. Referring to FIG. 1, the conventional inkjet image forming apparatus includes a printhead 10 forming an image by ejecting ink onto a top surface of a printing paper P, and a platen 20 supporting the printing paper P passing below the printhead 10. A head chip 15 on which a plurality of nozzles (not illustrated) are formed is placed on a bottom surface of the printhead 10 which faces the platen 20.

When ink is ejected, the printing paper P moves while being separated by a fixed head gap G from the printhead 10. The head gap G is a distance between a bottom surface of the head chip 15 and a back/bottom surface (i.e., opposite to the top surface) of the printing paper P.

In the conventional inkjet image forming apparatus, the head gap G is fixed to print on general printing paper. Accordingly, when printing is performed on other printing paper, such as an envelop or a postcard, which is thicker than the general printing paper, the other printing paper can contact the printhead 10, and therefore ink blurring (i.e., ink smearing) and other defective printing problems may occur.

### SUMMARY OF THE INVENTION

The present general inventive concept provides a device to adjust a head gap according to a thickness of a printing medium in order to prevent defective printing, and an image forming apparatus including the device.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a head gap adjusting device, including a platen including a plurality of medium supporting projections to support a printing medium, the plurality of medium supporting projections formed on a surface of the platen facing an array type printhead having a nozzle array at least equal to or longer than a width of the printing medium, a moving element to move the paper medium supporting projections towards or away from the printhead to adjust a head gap between the printhead and the printing medium, and a controller to control the moving element.

The head gap adjusting device may further include a plurality of gap maintaining projections protruding apart from a paper conveying path to maintain a predetermined minimum value of the head gap.

The platen may include a plate member including a surface facing the printhead and from which the medium supporting projections protrude.

The moving element may include a cam to rotate in contact with the plate member.

The head gap adjusting device may further include a head gap sensor to sense a size of the head gap in response to a rotation of the cam.

The head gap adjusting device may further include a spring to press the plate member towards the cam to keep the plate member and cam in contact with each other.

The platen may include a fixed member facing the printhead and comprising a plurality of penetration holes; and a moveable member comprising the medium supporting projections movably installed in a portion the plurality of penetration holes to move towards or away from the printhead.

The moveable member may further include a plurality of gap maintaining projections movably installed in another portion of the plurality of penetration holes to move towards or away from the printhead to maintain the predetermined minimum value of the head gap.

The plurality of penetration holes may correspond to the plurality of medium supporting projection and the plurality of gap maintaining projections, and the plurality of paper supporting projections and the plurality of gap maintaining projections may be moveable through the penetration holes.

The moving element may include a cam to rotate in contact with the moveable member.

The head gap adjusting device may further include a head gap sensor to sense a size of the head gap in response to a rotation of the cam.

The head gap adjusting device may further include a spring to press the moveable member towards the cam to keep the moveable member and the cam in contact with each other.

The foregoing and/or other aspects and utilities of the present general inventive concept may also be achieved by providing a head gap adjusting device, including a platen plate including a surface facing an array type printhead that includes a nozzle array at least equal to or longer than a width of a printing medium to support the printing medium, a gap adjusting sheet to adjust a size of a head gap by moving to a first position where the gap adjusting sheet overlaps the platen plate and a second position where the gap adjusting sheet is separated from the platen plate, a moving element to move the gap adjusting sheet to the first and second positions, and a controller to control the moving element.

The moving element may include a belt to support ends of the gap adjusting sheet, and a pair of supporting wheels to support the belt and allow the belt to move.

The foregoing and/or other aspects and utilities of the present general inventive concept may also be achieved by providing an image forming apparatus, including an array type printhead comprising a head chip having a plurality of nozzles to eject ink, and a platen unit to adjust a head gap between the head chip and the platen unit, the platen unit including a platen to support a printing medium passing under the head chip, and a platen moving unit to move the platen to a first position by a first predetermined distance from the head chip in a direction perpendicular to a conveying direction of the printing medium, and a second position by a second predetermined distance from the head chip in the direction perpendicular to a conveying direction of the printing medium.

The platen moving unit may include an elastic member to bias the platen away from the head chip in the direction perpendicular to a conveying direction of the printing medium. The elastic member may be fixed to a main body of the image forming apparatus.

The foregoing and/or other aspects and utilities of the present general inventive concept may also be achieved by providing a platen unit to adjust a head gap of an image forming apparatus including a printhead having a head chip, the platen unit including a platen to support a printing medium to receive ink ejected from the head chip in an image-wise pattern, and a platen moving unit to move the platen to a first position by a first predetermined distance from the head chip in a direction perpendicular to a conveying direction of the printing medium, and a second position by a second predetermined distance from the head chip in the direction perpendicular to a conveying direction of the printing medium.

The platen moving unit may include an elastic member to bias the platen towards the second position. The elastic member may include a first moveable end moveable with the platen, and a second fixed end. The head gap in the second position may be about 1.5 mm to about 2 mm, and the head gap in the first position is smaller than the head gap in the second position.

The platen moving unit may include a rotatable cam to move the platen to the first and second positions, and a control unit to control a rotation of the cam. The platen moving unit may further include an elastic member disposed at an end portion of the platen in a widthwise direction of the printing medium to maintain a contact between the moveable member and the cam. The platen may include at least one first protrusion on a top surface of the platen to contact a bottom surface of the printhead to maintain a predetermined minimum head gap size between the printhead and the platen, and a plurality of second protrusions on the top surface of the platen to support the printing medium as the printing medium passes under the head chip. The plurality of second protrusions may be disposed at regular intervals along the top surface of the platen. The platen unit may further include a detecting unit to detect whether the platen is in the first position and/or the second position.

The foregoing and/or other aspects and utilities of the present general inventive concept may also be achieved by providing a head gap adjusting unit to adjust a head gap of an image forming apparatus including a printhead having a head chip, the head gap adjusting unit including a moveable member comprising at least one first protrusion on a top surface thereof to contact a bottom surface of the printhead to maintain a predetermined minimum head gap size between the printhead and the platen, and a plurality of second protrusions on the top surface thereof to support a printing medium as the printing medium passes under the head chip, a fixed member comprising at least one first through-hole to accommodate the at least one first protrusion and a plurality of second through-holes to accommodate the plurality of second protrusions, and a moving unit to move the moveable member in a direction perpendicular to a conveying direction of the printing medium to a first position having a first predetermined head gap size and a second position having a second predetermined head gap size.

The moving unit may include an elastic member to bias the moveable member towards the second position. The second head gap size may be about 1.5 mm to about 2 mm, and the first head gap size is smaller than the second head gap size. The moving unit may include a rotatable cam to move the moveable member to the first and second positions, a control unit to control a rotation of the cam, and an elastic member disposed at an end portion of the platen in a widthwise direction of the printing medium to maintain a contact between the platen and the cam.

The foregoing and/or other aspects and utilities of the present general inventive concept may also be achieved by providing a head gap adjusting unit to adjust a head gap of an image forming apparatus including a printhead having a head chip, the platen unit including a fixed member to support a first printing medium facing the head chip to maintain a first predetermined gap size, a moveable member to support a second printing medium facing the head chip to maintain a second predetermined gap size that is smaller than the first predetermined gap size, and a moving unit to move the moveable platen to a first position on a top surface of the fixed member to support the second printing medium, and to a second position spaced apart from the fixed member to allow the fixed member to support the first printing medium.

The moving unit may include a belt to move the moveable member to the first and second positions, and first and second rotating members disposed at first and second ends, respectively, of the fixed member in a conveying direction of the printing medium to support a movement of the belt. The moveable member may completely cover the top surface of the fixed member in the first position. The moveable member may have a thickness corresponding to a difference between the first and second head gap sizes. The moveable member may have a thickness of about 0.5 mm to about 1 mm.

The foregoing and/or other aspects and utilities of the present general inventive concept may also be achieved by providing an image forming method useable in an image forming apparatus including an array type print head including a head chip and a platen, the method including supporting a first printing medium having a first thickness on the platen located at a first position a first predetermined distance from a bottom surface of the head chip in a direction perpendicular to a conveying direction of the first printing medium to print a first image on the first printing medium, moving the platen to a second position a second predetermined distance from the bottom surface of the head chip in the direction, and supporting a second printing medium having a second thickness different from the first thickness on the platen located at the second position to print a second image on the second printing medium.

The foregoing and/or other aspects and utilities of the present general inventive concept may also be achieved by providing an image forming apparatus, including an array type printhead comprising a head chip having a plurality of nozzles to eject ink, and a head gap adjusting unit to adjust a head gap between the head chip and the head gap adjusting unit, the head gap adjusting unit including a support unit comprising a moveable member to support a printing medium passing under the head chip at a first position having a first predetermined head gap distance in a direction perpendicular to a conveying direction of the printing medium, a moving unit to move the moveable member to the first position and to a second position having a second predetermined head gap distance in the direction, and a head gap maintaining unit to maintain a predetermined minimum head gap distance in the direction.

The moveable member may support the printing medium passing under the head chip at the second position, and the head gap maintaining unit may include at least one protrusion located on a surface of the moveable member to contact a bottom surface of the printhead to maintain the predetermined minimum head gap distance in the direction. The support unit may further include a fixed member to support the printing medium passing under the head chip at the second position, and the head gap maintaining unit may include a closed loop belt attached to the moveable member to limit a movement of the moveable member in the direction to maintain the predetermined minimum head gap distance in the direction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a printhead and a platen of a conventional inkjet image forming apparatus;

FIG. 2 is a cross-sectional view illustrating an inkjet image forming apparatus according to an embodiment of the present general inventive concept;

FIG. 3 is a front view illustrating a head gap adjusting device of FIG. 2 according to an embodiment of the present general inventive concept;

FIGS. 4 and 5 are side views illustrating the head gap adjusting device of FIG. 2;

FIGS. 6 and 7 are side views illustrating a head gap adjusting device according to another embodiment of the present general inventive concept,

FIG. 8 is a perspective view illustrating a part of the head gap adjusting device of FIG. 6; and

FIGS. 9 and 10 are side views illustrating a head gap adjusting device according to another embodiment of the present general inventive concept.

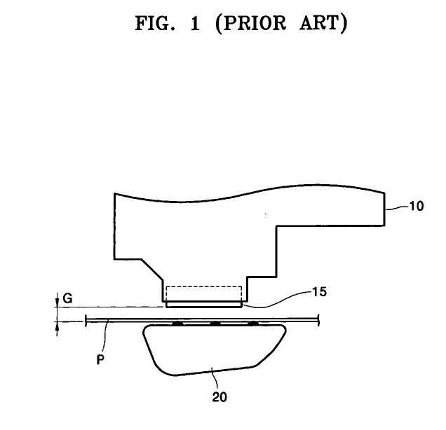

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

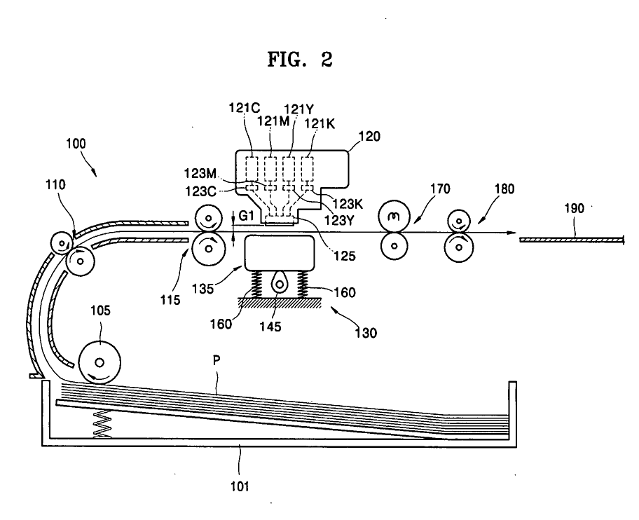

FIG. 2 is a cross-sectional view illustrating an inkjet image forming apparatus 100 according to an embodiment of the present general inventive concept. Referring to FIG. 2, the inkjet image forming apparatus 100 includes a paper conveying element to convey a printing medium, such as a printing paper P, in a predetermined direction, an array type printhead 120 to form an image by ejecting ink onto the printing paper P, and a head gap adjusting device 130 to adjust a head gap G (G1) between the head gap adjusting device 130 and the printhead 120 and to support the printing paper P.

The paper conveying element may include feeding rollers 110 to feed the printing paper P to pass below the array type printhead 120, and discharging rollers 180 to discharge the printing paper P on which the image is formed to a discharging tray 190. Each of the feeding rollers 110 and the discharging rollers 180 may include a driving roller and an idle roller which contact each other, and the printing paper P moves between the pair of contacting driving and idle rollers. A reference numeral 115 denotes registration rollers that align the printing paper P to form the image on a desired position on the printing paper P.

The inkjet image forming apparatus 100 further includes a paper feeding cassette 101 to contain sheets of printing paper P, a pickup roller 105 to pick up the printing paper P contained in the paper feeding cassette 101, and a drier 170 to dry the image formed by ejecting the ink onto the printing paper P. Since the inkjet image forming apparatus 100 including the array type printhead 120 prints fast, the sheets of printing paper P on which the image is formed may not be sufficiently dried, and since the sheets of printing paper P are sequentially stacked in the discharging tray 190, image smearing can occur. The drier 170 quickly dries the printed image, thereby preventing defective printing (e.g., by preventing the smearing).

The array type printhead 120 is disposed between the registration rollers 115 and the drier 170. The printhead 120 include four ink tanks 121C, 121M, 121Y, 121K to contain cyan (C) ink, magenta (M) ink, yellow (Y) ink, and black (K) ink, respectively, four negative pressure regulators 123C, 123M, 123Y, and 123K, and a head chip 125 on which a plurality of nozzles (not illustrated) to eject the ink are formed. The negative pressure regulators 123C, 123M, 123Y, and 123K regulate negative pressure of the ink flowing from corresponding ones of the four ink tank 121C, 121M, 121Y, and 121K to the head chip 125 to prevent air bubbles from entering the head chip 125 or the ink from leaking through the nozzles.

The head gap adjusting device 130 includes a platen 135 to support the printing paper P passing below the printhead 120, an extension spring 160, and a cam 145. The printing paper P supported by the platen 135 moves while being separated a predetermined head gap G1 from a bottom surface of the head chip 125. The image is formed on the printing paper P by four colors C, M, Y, and K of the ink ejected from the nozzles. The head gap G1 is a distance between the bottom surface of the head chip 125 and a bottom surface of the printing paper P supported by the platen 135. The extension spring 160 and the cam 145 may constitute a platen moving unit to adjust a gap between the platen 135 and the head chip 125.

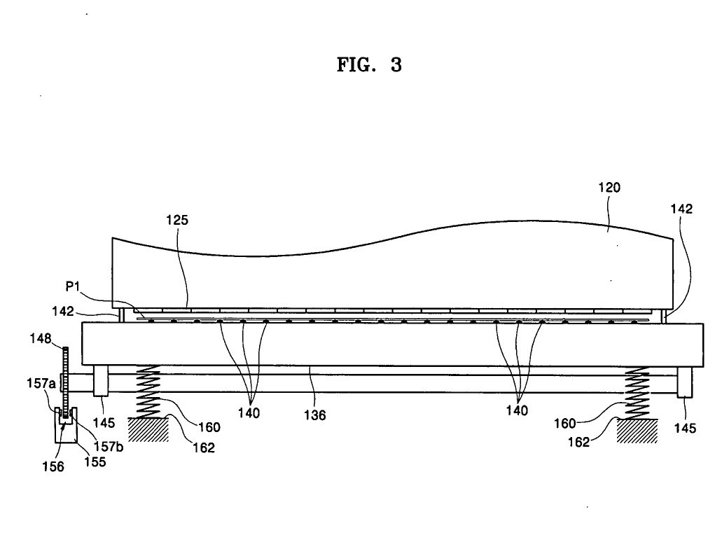

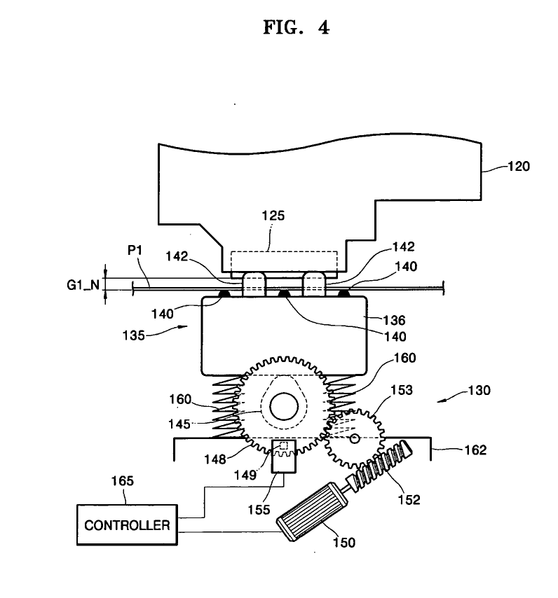

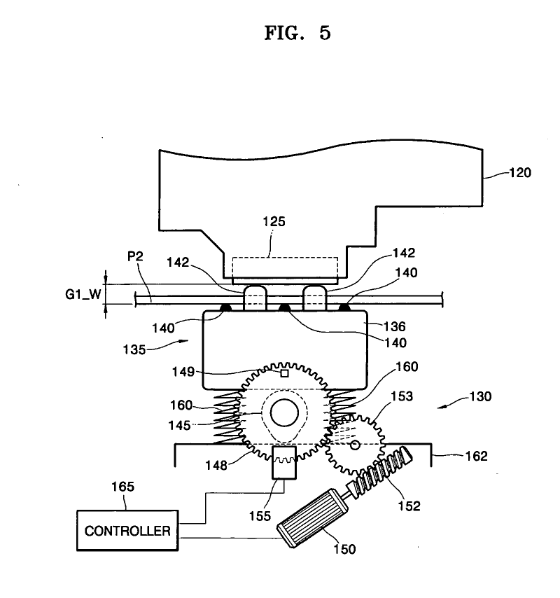

FIG. 3 is a front view illustrating the head gap adjusting device 130 of FIG. 2 according to an embodiment of the present general inventive concept, and FIGS. 4 and 5 are side views illustrating the head gap adjusting device 130 of FIG. 2. In FIG. 4, the head gap G1 is narrowed to be a narrow head gap G1_N, and in FIG. 5, the head gap G1 is widened to be a wide head gap G1_W.

Referring to FIGS. 3 through 5, the head gap adjusting device 130 includes a plate member 136 facing the printhead 120. The head gap adjusting device 130 also includes medium supporting projections 140 and gap maintaining projections 142 formed on a top surface of the plate member 136 facing the printhead 120. The plate member 136 extends in a widthwise direction of the printing paper P1 (FIG.3 and 4) or P2 (FIG. 5), the medium supporting projections 140 are formed in a middle portion of the plate member 136, and the gap maintaining projections 142 are formed on both ends of the plate member 136 in a lengthwise direction of the printing paper P1 or P2 apart from a paper conveying path. The gap maintaining projections 142 contact the bottom surface of the printhead 120 while being spaced apart from the head chip 125, thereby ensuring a predetermined minimum value of the head gap G1 (see FIG. 2), that is, the narrow head gap G1_N. The gap maintaining projections 142 protrude from the top surface of the plate member 136 to be higher than the medium supporting projections 140. The gap maintaining projections 142 may have equal heights. Similarly, the medium supporting projections 140 may have equal heights.

The head gap adjusting device 130 includes a moving element (platen moving unit) to move the medium supporting projections 140 and the gap maintaining projections 142 towards or away from the printhead 120, and a controller 165 to control the moving element. The moving element may include a cam 145 to rotate in contact with the bottom surface of the plate member 136 and a driving gear 148 concentrically engaged with the cam 145. The cam driving gear 148 may rotate clockwise or counter-clockwise due to a driving force from a motor 150. More specifically, a worm gear 152 is formed on a driving axis of the motor 150, and the worm gear 152 and the cam driving gear 148 are connected via a connection gear 153. A rotating direction and a degree of rotation of the motor 150 are controlled by a control signal of the controller 165. Further, the moving element may include an extension spring 160 to press the plate member 136 towards the cam 145 to keep the plate member 136 in contact with the cam 145. The extension spring 160 may be supported by a predetermined frame 162 of the inkjet image forming apparatus 100 (refer to FIG. 2).

The head gap adjusting device 130 may also include a head gap sensor 155 to detect a size of the head gap G1 (see FIG. 2) by a rotation position of the cam 145. The head gap sensor 155 may be a photo sensor including a light emitting unit 157a to emit light onto inner facing surfaces of a slot 156 and a light receiving unit 157b to receive the light emitted from the light emitting unit 157a. When the cam 145 rotates to locate the plate member 136 at a position closest to the printhead 120 as illustrated in FIG. 4, a sensing hole 149 is located at the slot 156 of the head gap sensor 155 and the light emitted from the light emitting unit 157a passes through the sensing hole 149 and is received by the light receiving unit 157b so that a sensing signal is produced. The controller 165 electrically connected to the head gap sensor 155 receives the sensing signal from the head gap sensor 155 and determines that the narrow head gap G1_N is formed between the printhead 120 and the plate member 136.

Hereinafter, referring to FIGS. 2 through 5 again, an operation of adjusting the head gap G1 by the head gap adjusting device 130 will be described. A narrow head gap G1_N illustrated in FIG. 4 may be a default setting of the head gap G1 (see FIG. 2) of the inkjet image forming apparatus 100. When a user stacks sheets of thick printing paper P2 (see FIG. 5), such as envelops or thick postcards, in the paper feeding cassette 101 and selects a thick paper printing mode via an input unit (such as input buttons) on the inkjet image forming apparatus 100 or a host computer connected to the inkjet image forming apparatus 100, the user's instruction is transmitted to the controller 165 and the controller 165 sends a driving control signal to the motor 150. The motor 150 drives the worm gear 152 such that the cam 145 rotates 180 degrees, and consequently, the plate member 136 is separated from the bottom surface of the printhead 120 to form the wide head gap G1_W, as illustrated in FIG. 5. The wide head gap G1-W may be set to, for example, 1.5 mm to 2 mm.

When the user stacks sheets of general printing paper P1 (referring to FIG. 4) again in the paper feeding cassette 101 (e.g., after printing with the thick printing paper P2) and selects a default paper printing mode via the input unit (such as the input buttons) on the inkjet image forming apparatus 100 or the host computer connected to the inkjet image forming apparatus 100, the user's instruction is transmitted to the controller 165 and the controller 165 sends a driving signal to the motor 150. The motor 150 drives the worm gear 152 such that the cam 145 rotates in a direction opposite to the rotation direction in the thick paper printing mode. Consequently, the plate member 136 approaches the bottom surface of the printhead 120 to form the narrow head gap G1_N, as illustrated in FIG. 4. Although the rotation of the cam 145 has been described as rotating 180 degrees from the default position to the thick paper printing position in a first direction (e.g., clockwise) and then rotating in the opposite direction 180 degrees back to the default position (e.g., counter clockwise), the present general inventive concept is not so limited. Thus, the cam 145 may rotate 180 degrees from the default position to the thick paper printing position in the first direction and then may rotate another 180 degrees in the same direction back to the default position.

When the sensing hole 149 of the cam driving gear 148 is located in the slot to overlap the head gap sensor 155, a sensing signal is transmitted to the controller 165. In response to the sensing signal, the controller 165 stops the motor 150 driving, and therefore, an error of the head gap G1_N due to over-rotation of the cam 145 is prevented. Meanwhile, the gap maintaining projections 142 maintains the narrow head gap G1_N between the bottom surface of the printhead 120 and the plate member 136 not to be narrower than a predetermined minimum value. Specifically, if leading ends of the gap maintaining projections 142 touch both end portions of the printhead 120, the plate member 136 can no longer move towards the printhead 120 despite the rotation of the cam 145. Therefore, even when the printhead 120, the plate member 136, the head chip 125, the plate member 136, or other elements are deformed, the narrow head gap G1_N is not smaller than the predetermined minimum value.

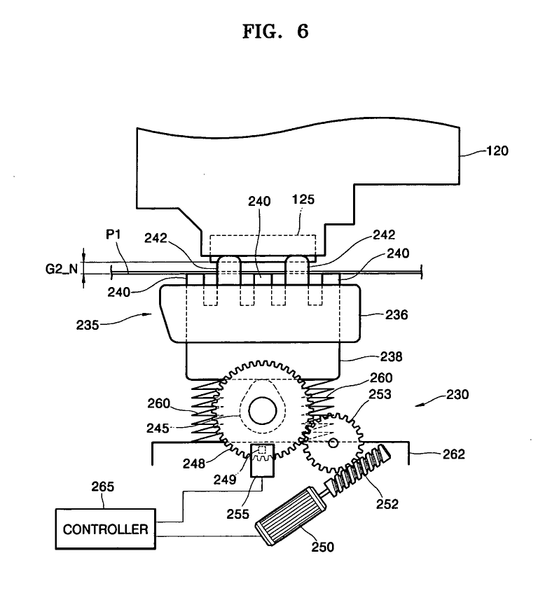

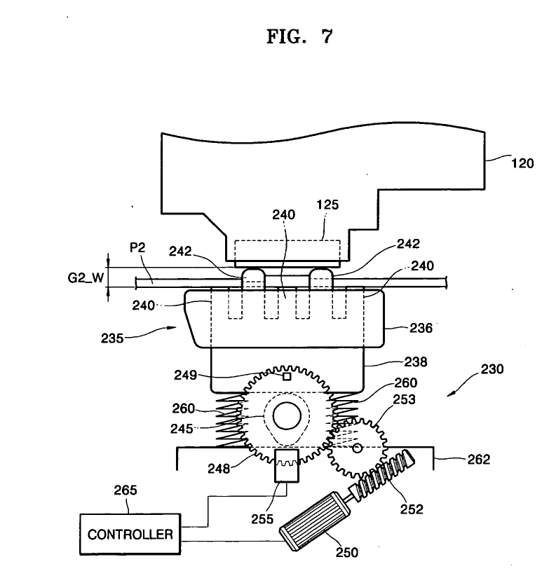

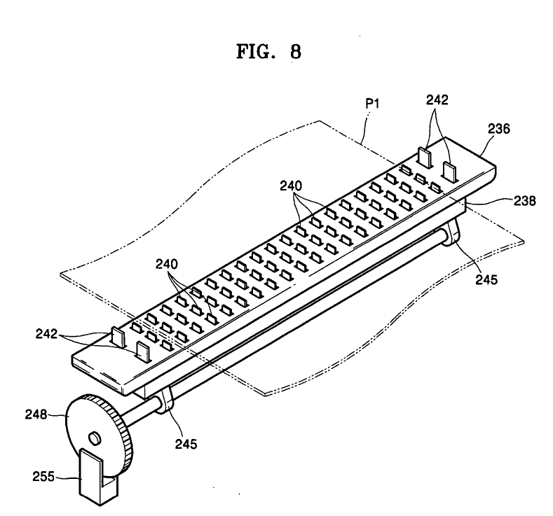

FIGS. 6 and 7 are side views illustrating a head gap adjusting device 230 according to another embodiment of the present general inventive concept. In FIG. 6, a head gap is narrowed, and in FIG. 7, the head gap is widened. FIG. 8 is a perspective view illustrating a part of the head gap adjusting device 230 of FIG. 6. The head gap adjusting device 230 illustrated in FIGS. 6, 7, and 8 can substitute for the head gap adjusting device 130 included in the inkjet image forming apparatus 100 illustrated in FIG. 2.

Referring to FIGS. 6 through 8, the head gap adjusting device 230 includes a platen 235. The platen 235 includes a first member 236 fixed opposite to a bottom surface of a printhead 120, and a second member 238 on which medium supporting projections 240 and gap maintaining projections 242 are formed. All of the medium supporting projections 240 and the gap maintaining projections 242 may penetrate a top surface of the first member 236, facing a head chip 125 of a bottom surface of the printhead 120, and may be moved towards or away from the printhead 120. The first member 236 may be extended in a widthwise direction of a general printing paper P1 or a thick printing paper P2. Furthermore, the medium supporting projections 240 of the second member 238 may protrude through a middle portion of the first member 236, and the gap maintaining projections 242 may protrude through both end portions in a lengthwise direction of the first member 236, apart from a paper conveying path. The gap maintaining projections 242 contact the bottom surface of the printhead 120 while being apart from the head chip 125, thereby ensuring a narrow head gap G2_N. The gap maintaining projections 242 may protrude from the top surface of the first member 236 to be higher than the paper supporting projections 240. The gap maintaining projections 242 may have equal heights. Similarly, the medium supporting projections 240 may have equal heights.

The head gap adjusting device 230 includes a moving element to move the medium supporting projections 240 and the gap maintaining projections 242 towards or away from the printhead 120, and a controller 265 to control the moving element. The moving element may include a cam 245 to rotate in contact with a bottom surface of the second member 238, and a cam driving gear 248 concentrically engaged with the cam 245. The cam driving gear 248 may rotate clockwise or counter-clockwise due to a driving force of a motor 250. A worm gear 252 is formed on a rotation axis of the motor 250, and the worm gear 252 and the cam driving gear 248 are connected via a connection gear 253. A rotation direction and a degree of rotation of the rotation axis of the motor 250 are controlled by a control signal of the controller 265. The moving element may include an extension spring 260 to press the second member 238 towards the cam 245 to keep the second member 238 and the cam in contact with each other. The extension spring 260 may be supported by a predetermined supporting frame 262 of the image forming apparatus 10 (see FIG. 2).

The head gap adjusting device 230 may include a head gap sensor 255 to detect a size of the head gap by a rotation position of the cam 245. A sensing hole 249 may be formed in an outer circumference of the cam driving gear 248. The controller 265 electrically connected to the head gap sensor 255 may then receive a sensing signal from the head gap sensor 255 and may determine that the narrow head gap G2_N is formed between the printhead 120 and the platen 235.

The narrow head gap G2-N as illustrated in FIG. 6 may be a default setting of the head gap of the inkjet image forming apparatus 100 (see FIG. 2). When a user stacks sheets of thick printing paper P2 in the paper feeding cassette 101 (see FIG. 2) and selects a thick paper printing mode via an input unit (such as input buttons) on the inkjet image forming apparatus 100 or a host computer connected to the inkjet image forming apparatus 100, the user's instruction is transmitted to the controller 265, and the controller 265 sends a driving control signal to the motor 250. The motor 250 drives the worm gear 252 such that the cam 245 rotates 180 degrees. Consequently, the second member 238 is separated from the bottom surface of the printhead 120, so that a wide head gap G2_W is formed, as illustrated in FIG. 7.

When the user stacks sheets of general printing paper P1 again in the paper feeding cassette 101 (e.g., after printing with the thick printing paper P2) and selects a default paper printing mode via the input unit (such as the input buttons) on the image forming apparatus 100 or the host computer connected to the image forming apparatus 100, the user's instruction is transmitted to the controller 265, and the controller 265 sends a driving control signal to the motor 250. The motor 250 drives the worm gear 252 such that the cam 245 rotates in a direction reverse to the direction in the thick paper printing mode. As a result, the second member 238 moves towards the bottom surface of the printhead 120 to form a narrow head gap G2_N, as illustrated in FIG. 6. Although the rotation of the cam 245 has been described as rotating 180 degrees from the default position to the thick paper printing position in a first direction (e.g., clockwise) and then rotating in the opposite direction 180 degrees back to the default position (e.g., counter clockwise), the present general inventive concept is not so limited. Thus, the cam 245 may rotate 180 degrees from the default position to the thick paper printing position in the first direction and then may rotate another 180 degrees in the same direction back to the default position.

When the sensing hole 249 of the cam driving gear 248 is located to overlap the head gap sensor 255, the sensing signal is transmitted to the controller 265. In response to the sensing signal, the controller 265 stops the motor 250 rotating, and thus an error of the head gap G2_N due to over-rotation of the cam 245 is prevented. Meanwhile, the gap maintaining projections 242 maintains the narrow head gap G2_N between the bottom surface of the printhead 120 and the paper supporting projections 240 not to be narrower than a predetermined minimum value. More specifically, if the leading ends of the gap maintaining projections 242 touch both end portions of the printhead 120, the paper supporting projections 240 can no longer move towards the printhead 120 despite the rotation of the cam 245. Thus, even when the printhead 120, the second member 238, the printhead 120, the second member 238, or other elements is deformed, the narrow head gap G2_N is not smaller than the predetermined minimum value.

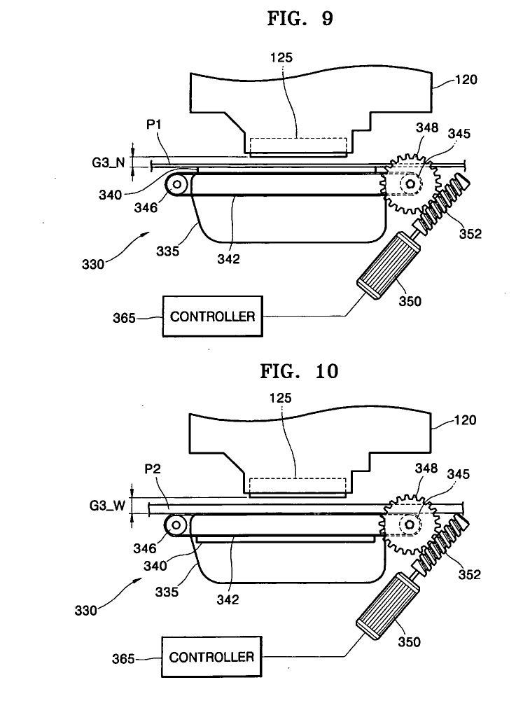

FIGS. 9 and 10 are side views illustrating a head gap adjusting device 330 according to another embodiment of the present general inventive concept. In FIG. 9, a head gap is narrowed, and in FIG. 10, the head gap is widened. The head gap adjusting device 330 can substitute for the head gap adjusting device 130 included in the inkjet image forming apparatus 100 illustrated in FIG. 2.

Referring to FIGS. 9 and 10, the head gap adjusting device 330 includes a platen plate 335 to support a thin printing paper P1 or a thick printing paper P2 on a top surface thereof facing a head chip 125 of a bottom surface of a printhead 120. The head gap adjusting device 330 further includes a gap adjusting sheet 340, a moving element to move the gap adjusting sheet 340 to a first position where the gap adjusting sheet 340 overlaps a top surface of the platen plate 335 (as illustrated in FIG. 9) and to a second position where the gap adjusting sheet 340 is separated from the platen plate 335 (as illustrated in FIG. 10), and a controller 365 that controls the moving element. The gap adjusting sheet 340 may be of a size sufficient to cover the top surface of the platen plate 335, and may have a thickness of, for example, 0.5 mm to 1 mm, to correspond to a difference between a narrow head gap G3_N and a wide head gap G3_W. Furthermore, the gap adjusting sheet 340 may extend longer than the platen plate 335 in a widthwise direction of the printing paper P1 or P2 so that both ends of the gap adjusting sheet 340 protrude farther than ends of the platen plate 335. In the present embodiment, the gap adjusting sheet 340 may be formed of a material, for example, polycarbonate, that produces less friction between the gap adjusting sheet 340 and the printing paper P1 or P2 or the top surface of the platen plate 335.

The moving element may include a belt 342 to support the ends of the gap adjusting sheet 340, and first and second supporting wheels 345 and 346 to support the belt 342 and to allow the belt 342 to move. The first and second wheels 345 and 346 are arranged at a front and a rear of the platen plate 335 in a moving direction of the printing paper P1 or P2. A driving gear 348 is concentrically connected to the first supporting wheel 345, and a worm gear 352 formed on the rotation axis of a motor 350 is engaged with the driving gear 348. A rotation direction and a degree of rotation of a rotation axis of the motor 350 are controlled by a control signal of the controller 365.

When a user stacks sheets of the thin printing paper P1 in the paper feeding cassette 101 of the inkjet image forming apparatus 100 (see FIG. 2) and selects a thin paper printing mode via an input unit (such as input buttons) on the inkjet image forming apparatus 100 or a host computer connected to the inkjet image forming apparatus 100, the user's instruction is transmitted to the controller 365, and the controller 365 sends a driving control signal to the motor 350. In response to the driving control signal, the gap adjusting sheet 340 is moved to a first position where the gap adjusting sheet 340 overlaps a top surface of the platen plate 335 so that the narrow head gap G3_N is formed between the printhead 120 and the platen plate 335, as illustrated in FIG. 9.

When the user stacks sheets of the thick printing paper P2 in the paper feeding cassette 101 and selects a thick paper printing mode via the input unit (such as the input buttons) on the inkjet image forming apparatus 100 or the host computer connected to the inkjet image forming apparatus 100, the user's instruction is transmitted to the controller 365, and the controller 365 sends a driving control signal to the motor 350. Due to the driving of the motor 350, the gap adjusting sheet 340 is moved to a second position where the gap adjusting sheet 340 is separated from the top surface of the platen plate 335 so that the wide head gap G3_W is formed between the printhead 120 and the platen plate 335, as illustrated in FIG. 10.

According to embodiments of the present general inventive concept, a head gap adjusting device and an inkjet image forming apparatus including the same can adjust a head gap according to a thickness of a printing medium, to prevent defective printing, such as smearing, and to obtain good printing quality regardless of a thickness of the printing medium.

Moreover, according to embodiments of the present general inventive concept, since gap maintaining projections are formed on a head gap adjusting device, a narrow head gap suitable for thin printing medium is maintained at an optimum distance.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A head gap adjusting device, comprising:
a platen including a plurality of medium supporting projections to support a printing medium, the plurality of medium supporting projections formed on a surface of the platen facing an array type printhead having a nozzle array at least equal to or longer than a width of the printing medium;
a moving element to move the medium supporting projections towards or away from the printhead to adjust a head gap between the printhead and the printing medium; and
a controller to control the moving element.

2. The head gap adjusting device of claim 1, further comprising:
a plurality of gap maintaining projections protruding apart from a paper conveying path to maintain a predetermined minimum value of the head gap.

3. The head gap adjusting device of claim 1, wherein the platen comprises:
a plate member including a surface facing the printhead and from which the medium supporting projections protrude.

4. The head gap adjusting device of claim 3, wherein the moving element comprises:
a cam to rotate in contact with the plate member.

5. The head gap adjusting device of claim 4, further comprising:
a head gap sensor to sense a size of the head gap in response to a rotation of the cam.

6. The head gap adjusting device of claim 4, further comprising:
a spring to press the plate member towards the cam to keep the plate member and cam in contact with each other.

7. The head gap adjusting device of claim 1, wherein the platen comprises:
a fixed member facing the printhead and comprising a plurality of penetration holes; and
a moveable member comprising the medium supporting projections movably installed in a portion the plurality of penetration holes to move towards or away from the printhead.

8. The head gap adjusting device of claim 7, wherein the moveable member further comprises:
a plurality of gap maintaining projections movably installed in another portion of the plurality of penetration holes to move towards or away from the printhead to maintain the predetermined minimum value of the head gap.

9. The head gap adjusting device of claim 8, wherein the plurality of penetration holes correspond to the plurality of medium supporting projection and the plurality of gap maintaining projections, and the plurality of paper supporting projections and the plurality of gap maintaining projections are moveable through the penetration holes.

10. The head gap adjusting device of claim 7, wherein the moving element comprises a cam to rotate in contact with the moveable member.

11. The head gap adjusting device of claim 10, further comprising:
a head gap sensor to sense a size of the head gap in response to a rotation of the cam.

12. The head gap adjusting device of claim 10, further comprising:
a spring to press the moveable member towards the cam to keep the moveable member and the cam in contact with each other.

13. A head gap adjusting device, comprising:
a platen plate including a surface facing an array type printhead that includes a nozzle array at least equal to or longer than a width of a printing medium to support the printing medium;
a gap adjusting sheet to adjust a size of a head gap by moving to a first position where the gap adjusting sheet overlaps the platen plate and a second position where the gap adjusting sheet is separated from the platen plate;
a moving element to move the gap adjusting sheet to the first and second positions; and
a controller to control the moving element.

14. The head gap adjusting device of claim 13, wherein the moving element comprises:
a belt to support ends of the gap adjusting sheet; and
a pair of supporting wheels to support the belt and allow the belt to move.

15. An inkjet image forming apparatus, comprising:
an array type printhead to eject ink to form an image on a printing medium; and
a head gap adjusting device to form a size-adjustable head gap together with the printhead and to support the printing medium,
wherein the head gap adjusting device comprises:
a platen including a plurality of medium supporting projections to support the printing medium, the plurality of medium supporting projections formed on a surface of the platen facing the printhead;
a moving element to move the medium supporting projections towards or away from the printhead to adjust a size of the head gap; and
a controller to control the moving element.

16. The head gap adjusting device of claim 15, further comprising:
a plurality of gap maintaining projections protruding apart from a medium conveying path to maintain a predetermined minimum value of the head gap.

17. The inkjet image forming apparatus of claim 15, wherein the platen comprises:
a plate member including a surface facing the printhead and from which the medium supporting projections and the gap maintaining projections protrude.

18. The inkjet image forming apparatus of claim 17, wherein the moving element comprises:
a cam to rotate in contact with the plate member.

19. The inkjet image forming apparatus of claim 18, further comprising:
a head gap sensor to sense the size of the head gap in response to a rotation of the cam.

20. The inkjet image forming apparatus of claim 18, further comprising:
a spring to press the plate member towards the cam to keep the plate member and cam in contact with each other.

21. The inkjet image forming apparatus of claim 15, wherein the platen comprises:
a fixed member facing the printhead and comprising a plurality of penetration holes; and
a moveable member comprising the medium supporting projections movably installed in a portion of the plurality of penetration holes to move towards or away from the printhead.

22. The inkjet image forming apparatus of claim 21, wherein the moveable member further comprises:
a plurality of gap maintaining projections movably installed in another portion of the plurality of penetration holes to move towards or away from the printhead and to maintain a predetermined minimum value of the head gap.

23. The inkjet image forming apparatus of claim 22, wherein the plurality of penetration holes correspond to the plurality of medium supporting projection and the plurality of gap maintaining projections, and the plurality of medium supporting projections and the plurality of gap maintaining projections are moveable through the penetration holes.

24. The inkjet image forming apparatus of claim 21, wherein the moving element comprises:
a cam to rotate in contact with the moveable member.

25. The inkjet image forming apparatus of claim 24, wherein the head gap adjusting device further comprises:
a head gap sensor to sense the size of the head gap in response to a rotation of the cam.

26. The inkjet image forming apparatus of claim 24, wherein the head gap adjusting device further comprises:
a spring to press the moveable member towards the cam to keep the moveable member and the cam in contact with each other.

27. An inkjet image forming apparatus, comprising:
an array type printhead to eject ink to form an image on a printing medium; and
a head gap adjusting device to form a size-adjustable head gap together with the printhead and to support the printing medium,
wherein the head gap adjusting device comprises:
a platen plate including a surface facing the printhead to support the printing medium;
a gap adjusting sheet to adjust a size of the head gap by moving to a first position where the gap adjusting sheet overlaps the platen plate and a second position where the gap adjusting sheet is separated from the platen plate;
a moving element to move the gap adjusting sheet to the first and second positions; and
a controller to control the moving element.

28. The inkjet image forming apparatus of claim 27, wherein the moving element comprises:
a belt to support ends of the gap adjusting sheet; and
a pair of supporting wheels to support the belt and allow the belt to move.

29. An image forming apparatus, comprising:
an array type printhead comprising a head chip having a plurality of nozzles to eject ink; and
a platen unit to adjust a head gap between the head chip and the platen unit, the platen unit comprising:
a platen to support a printing medium passing under the head chip, and
a platen moving unit to move the platen to a first position by a first predetermined distance from the head chip in a direction perpendicular to a conveying direction of the printing medium, and a second position by a second predetermined distance from the head chip in the direction perpendicular to a conveying direction of the printing medium.

30. The image forming apparatus of claim 29, wherein the platen moving unit comprises:
an elastic member to bias the platen away from the head chip in the direction perpendicular to a conveying direction of the printing medium.

31. The image forming apparatus of claim 30, wherein the elastic member is fixed to a main body of the image forming apparatus.

32. A head gap adjusting unit to adjust a head gap of an image forming apparatus including a printhead having a head chip, the head gap adjusting unit comprising:
a moveable member comprising at least one first protrusion on a top surface thereof to contact a bottom surface of the printhead to maintain a predetermined minimum head gap size between the printhead and the platen, and a plurality of second protrusions on the top surface thereof to support a printing medium as the printing medium passes under the head chip;
a fixed member comprising at least one first through-hole to accommodate the at least one first protrusion and a plurality of second through-holes to accommodate the plurality of second protrusions; and
a moving unit to move the moveable member in a direction perpendicular to a conveying direction of the printing medium to a first position having a first predetermined head gap size and a second position having a second predetermined head gap size.

33. The head gap adjusting unit of claim 32, wherein the moving unit comprises:
a rotatable cam to move the moveable member to the first and second positions;
a control unit to control a rotation of the cam; and
an elastic member disposed at an end portion of the platen in a widthwise direction of the printing medium to maintain a contact between the moveable member and the cam.

34. A head gap adjusting unit to adjust a head gap of an image forming apparatus including a printhead having a head chip, the head gap adjusting unit comprising:
a fixed member to support a first printing medium facing the head chip to maintain a first predetermined gap size;
a moveable member to support a second printing medium facing the head chip to maintain a second predetermined gap size that is smaller than the first predetermined gap size; and
a moving unit to move the moveable platen to a first position on a top surface of the fixed member to support the second printing medium, and to a second position spaced apart from the fixed member to allow the fixed member to support the first printing medium.

35. The head gap adjusting unit of claim 34, wherein the moving unit comprises:
a belt to move the moveable member to the first and second positions; and
first and second rotating members disposed at first and second ends, respectively, of the fixed member in a conveying direction of the printing medium to support a movement of the belt.

36. The head gap adjusting unit of claim 34, wherein the moveable member completely covers the top surface of the fixed member in the first position.

37. The head gap adjusting unit of claim 34, wherein the moveable member has a thickness corresponding to a difference between the first and second head gap sizes.

38. The head gap adjusting unit of claim 34, wherein the moveable member has a thickness of about 0.5 mm to about 1 mm.

39. An image forming method useable in an image forming apparatus comprising an array type print head including a head chip and a platen, the method comprising:
supporting a first printing medium having a first thickness on the platen located at a first position a first predetermined distance from a bottom surface of the head chip in a direction perpendicular to a conveying direction of the first printing medium to print a first image on the first printing medium;
moving the platen to a second position a second predetermined distance from the bottom surface of the head chip in the direction; and
supporting a second printing medium having a second thickness different from the first thickness on the platen located at the second position to print a second image on the second printing medium.

40. An image forming apparatus, comprising:
an array type printhead comprising a head chip having a plurality of nozzles to eject ink; and
a head gap adjusting unit to adjust a head gap between the head chip and the head gap adjusting unit, the head gap adjusting unit comprising:
a support unit comprising a moveable member to support a printing medium passing under the head chip at a first position having a first predetermined head gap distance in a direction perpendicular to a conveying direction of the printing medium,
a moving unit to move the moveable member to the first position and to a second position having a second predetermined head gap distance in the direction, and
a head gap maintaining unit to maintain a predetermined minimum head gap distance in the direction.

41. The apparatus of claim 40, wherein the moveable member supports the printing medium passing under the head chip at the second position, and the head gap maintaining unit includes at least one protrusion located on a surface of the moveable member to contact a bottom surface of the printhead to maintain the predetermined minimum head gap distance in the direction.

42. The apparatus of claim 40, wherein the support unit further comprises:
a fixed member to support the printing medium passing under the head chip at the second position, and the head gap maintaining unit includes a closed loop belt attached to the moveable member to limit a movement of the moveable member in the direction to maintain the predetermined minimum head gap distance in the direction.
